(19) United States
(12) Patent Application Publication
(10) Pub. No.: US 2025/0298121 A1
(43) Pub. Date: Sep. 25, 2025

(54) GROUND CLUTTER MITIGATION WITH HALF-DUPLEX CIRCULARLY POLARIZED AESA RADAR

(71) Applicant: Rockwell Collins, Inc., Cedar Rapids, IA (US)

(72) Inventors: James West, Cedar Rapids, IA (US); Venkata Sishtla, Cedar Rapids, IA (US)

(21) Appl. No.: 19/081,723

(22) Filed: Mar. 17, 2025

Related U.S. Application Data
(60) Provisional application No. 63/569,587, filed on Mar. 25, 2024.

(51) Int. Cl. G01S 7/292; G01S 7/02; G01S 13/02; G01S 13/44; G01S 13/95

(52) U.S. Cl. CPC G01S 7/292; G01S 7/026; G01S 13/4463; G01S 13/953; G01S 2013/0254

(57) ABSTRACT

An aerial monopulse active electronically scanned array (AESA) radar system includes a phased array of independently controllable radio frequency (RF) channels, a beamforming module, and a transmit/receive module. The beamforming module is configured to cause the phased array to produce a radiation pattern with intercardinal sidelobes oriented along a shortest axis to ground, during flight. The transmit/receive module is configured to half-duplex operation of the phased array by switching between left-hand circular polarization and right-hand circular polarization.

### CROSS-REFERENCE TO RELATED APPLICATION(S)

This application claims the benefit of U.S. Provisional Application No. 63/569,587 filed Mar. 25, 2024 for “GROUND CLUTTER MITIGATION WITH HALF-DUPLEX CIRCULARLY POLARIZED AESA RADAR” by J. West and V. Sishtla.

### BACKGROUND

The present disclosure relates generally to monopulse radar, and more particularly to systems and methods for mitigating ground clutter and other forms of noise or interference in monopulse active electronically scanned array (AESA) radar systems.

Radar systems, including electronically scanned array (ESA) radar systems, have recently begun to see use in commercial aerospace applications to collect meteorological data. Airborne weather radar can include dedicated weather radar hardware, and/or multipurpose radar systems capable of detecting and identifying relevant weather conditions, but used responsible for other tasks (e.g., collision avoidance, target or surface identification). AESA radar, in particular, offers extremely high resolution at relatively small antenna size by forming multiple beams of radio waves (sum and difference beams) simultaneously, and minimizing composite error signal to locate targets.

Although airborne weather radar systems are also used to detect weather conditions above or around an aircraft, ground clutter presents a special challenge to the collection of useful data from downward antenna beams intended to display doppler returns from, e.g., hazardous weather near a landing location.

Severe weather close to the ground can pose particularly risks to commercial aircraft at low altitudes. More generally, factors such as wind, precipitation, and surface conditions (e.g., water, ice) can determine appropriate flight behavior. Microbursts and unanticipated wind shear can pose particularly high dangers to descending aircraft during landing, when engine power is reduced and landing gear and flaps are extended, and aircraft total energy state is consequently low. Accurate identification of hazardous weather conditions near the ground allows pilots and/or aircraft systems to land safely without false alerts that might otherwise demand landings be discontinued and reattempted, causing increased fuel consumption and longer flight time.

Ground-directed radar is necessary in a variety of application outside of weather detection. Airborne rescue operations, for example, can demand radar identification of targets in need of assistance on the ground or in water. More broadly, any radar application in which ground clutter can tend to overwhelm useful signal presents special challenges for AESA radar systems. There exists a need for radar systems and algorithms well suited to collecting weather and other data near the ground. AESA radar advantageously offers high resolution on an airborne platform, but introduces special challenges as will be discussed below. Existing ground clutter suppression approaches, such as using Space-Time Adaptive Processing (STAP), can be computationally expensive, requiring heavy and expensive hardware and demanding prohibitive amounts of power.

### SUMMARY

In one aspect, this disclosure presents a method for suppressing ground clutter in a monopulse active electronically scanned array (AESA) radar system that includes a phased array of RF channels, each associated with an emitter element. The method includes identifying an axis transverse to a borescope axis defining a shortest path to a ground surface, and forming a plurality of monopulse beams using the phased array, such that the beams have radiation patterns with intercardinal sidelobes oriented along the identified axis. The phased array alternates between right-hand circular polarization and left-hand circular polarization with timing selected for half-duplexing for radiation and detection of radar returns.

In another aspect, this disclosure presents an aerial monopulse active electronically scanned array (AESA) radar system with a phased array of independently controllable radio frequency (RF) channels, a beamforming module, and a transmit/receive module. The beamforming module is configured to cause the phased array to produce a radiation pattern with intercardinal sidelobes oriented along a shortest axis to ground, during flight. The transmit/receive module is configured to half-duplex operation of the phased array by switching between left-hand circular polarization and right-hand circular polarization.

In still another aspect, this disclosure presents a method for suppressing ground clutter in a monopulse AESA radar system including a phased array of radio-frequency channels. This method includes emitting radiation in a plurality of monopulse beams from the phased array, while the phased array is circularly polarized in a first direction, and receiving first and second radar returns while the phased array is co-polarized and cross-polarized, respectively, with the first direction. Ground clutter is then identified based on comparison of ground clutter strength in the first and second radar returns, and subtracted from the first radar returns to produce a ground clutter-reduced radar signal.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a simplified schematic overhead view of an aircraft-mounted monopulse radar system.

FIG. 2 is a schematic system diagram of the monopulse radar system of FIG. 1.

FIG. 3a is a simplified overlay illustrating sidelobe orientations in a conventional horizontally polarized monopulse radar system consistent with FIGS. 1 and 2.

FIG. 3b is a simplified overlay illustrating sidelobe orientations in a 45° shifted, circularly polarized, monopulse radar system enabled by the half-duplexing of circularly RHCP Tx and LHCP Rx radar pulses.

While the above-identified figures set forth one or more embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

This disclosure presents methods and systems for suppressing ground clutter in aerial radar systems by: 1) orienting intercardinal sidelobes toward ground clutter sources, and 2) toggling or switching between right-hand and left-hand circular polarization in radar receive mode. For desired radar target returns, polarization mismatches are avoided through circular array polarization. To facilitate reception of radar returns, circular polarization is flipped between radiation and return reception. The resulting polarization-diverse, half-duplex, circularly polarized system greatly reduces ground clutter from sidelobe radiation and allows sidelobe returns to be distinguished based on travel time. Although this disclosure focuses on the mitigation of ground clutter, aspects of the approaches and systems disclosed herein can also advantageously be applied to the avoidance or suppression of noise or undesirable signal from other known locations.

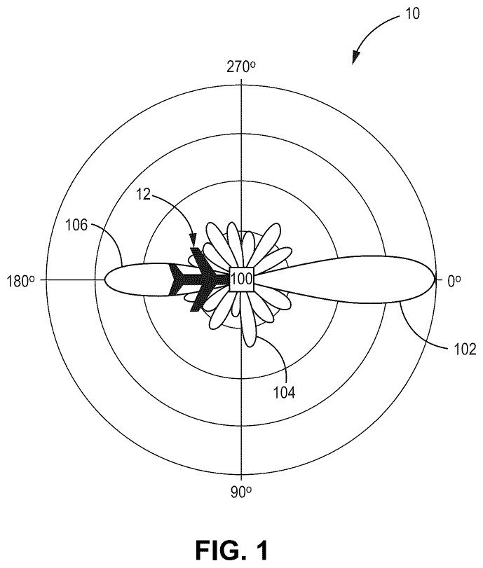

FIG. 1 is a simplified schematic overhead view of radar system 10, an aerial weather radar system. Radar system 10 is disposed on aircraft 12, and includes monopulse radar 100, a three-beam AESA radar system capable of downward, ground-facing imaging while aircraft 12 is in flight. For simplicity of illustration, FIG. 1 depicts only one of the three beams generated by monopulse radar 100. Monopulse radar 100 includes at least one antenna with multiple (e.g., 10,024) discrete elements, each with dedicated RF channels, coordinated as a phased array to generate beams directed to sweep, scan, or otherwise traverse a space that can include surface geography. As shown in the simplified illustration of FIG. 1, radiation making up a beam of monopulse radar 100 is characterized geometrically by multiple lobes. Although a main lobe 102 may be directed at locations of interest by tuning phases and amplitudes of radiation emissions from radio frequency channels of monopulse radar 100, sidelobes 104, including back lobe 106, will unavoidably be produced as well. Sidelobes 104 can contribute to ground clutter. Although back lobe 106 can have high amplitude relative to individual sidelobes 104, back lobe effects are generally less significant to radar performance than side lobe effects due both to the highly directional nature of “forward looking” AESA radar, and to electromagnetic blockage by the structure of aircraft 12.

Without ground clutter suppression, signal from ground returns can overwhelm signal corresponding to relevant weather conditions. This is particularly true for weather conditions close to the ground, such as wind shear and microbursts, and for conditions on the ground itself, such as ice or snow, which can present serious hazards to landing aircraft.

Although the uses and advantages of radar system 10 and monopulse radar 100 are described principally in terms of hazardous weather detection, it should be understood that radar system 10 can also be used for, and/or include components specialized for imaging of, non-weather phenomenal, including for object detection, collision avoidance, geolocation data collection, search, and rescue. Similarly, although this invention is described mainly in terms of ground clutter suppression, the basic operating principles described herein can be applied to nulling for other applications, i.e., of noise or interference other than ground clutter.

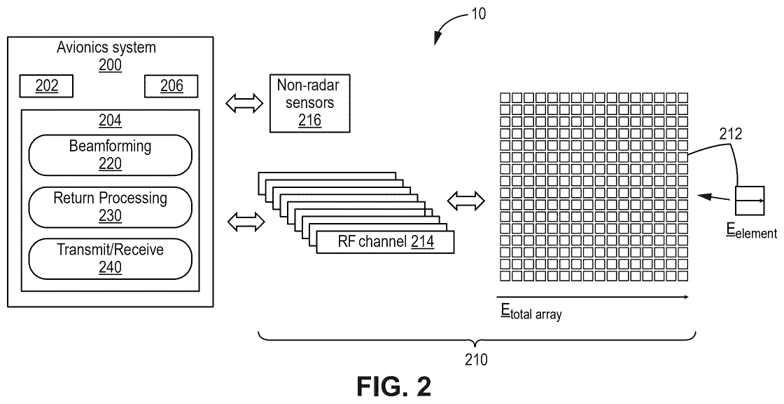

FIG. 2 is a schematic system diagram hardware and logic components of radar system 10. FIG. 2 illustrates avionics system 200 (with processor 202, memory 204, and interface 206) and active electronically scanned array (AESA) 210. AESA 210 can, for example, be a half duplexed Tx and Rx AESA with multiple discrete emitter/receiver elements 212 each having a corresponding dedicated radio frequency (RF) channel 214. Each RF channel 214 can, for example, include a beamforming RF integrated circuit (Beam Forming Integrated Circuit, i.e., BFIC) and transmit/receive module (TRM). RF channels 214 are collectively governed and coherently aggregated by hardware, firmware, and software within beamforming module 220 (described below).

Radar system 10 also includes or otherwise receives inputs from non-radar sensors 216. In addition to operating elements of radar system 10 as described below, avionics system 200 can be responsible for other necessary functions of aircraft 12, including tasks related to navigation, communication, and diagnostics, some of which can involve non-radar sensors 216. Further or alternatively, elements illustrated in FIG. 2 as components of avionics system 200 can be offloaded to separate hardware communicatively coupled to, but separable from, avionics system hardware.

Processor 202 is a logic capable device that can execute software, applications, and/or programs stored on memory 204. Examples of processor 202 can include one or more of a processor, a microprocessor, a controller, a digital signal processor (DSP), an application specific integrated circuit (ASIC), a field-programmable gate array (FPGA), or other equivalent discrete or integrated logic circuitry. Processor 202 can be entirely or partially mounted on one or more circuit boards.

Memory 204 is configured to store information and, in some examples, can be described as a computer-readable storage medium. Memory 204, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 204 is a temporary memory. As used herein, a temporary memory refers to a memory having a primary purpose that is not long-term storage. Memory 204, in some examples, is described as volatile memory. As used herein, a volatile memory refers to a memory that that the memory does not maintain stored contents when power to the memory 204 is turned off. Examples of volatile memories can include random access memories (RAM), dynamic random-access memories (DRAM), static random-access memories (SRAM), and other forms of volatile memories. In some examples, the memory is used to store program instructions for execution by the processor. The memory, in one example, is used by software or applications running on server 100 to temporarily store information during program execution. Memory 204 can, in some embodiments, store calibrations for specific AESA antenna configurations and/or RF channel phases and amplitudes.

Interface 206 is an input and/or output device, set of devices, and/or software interface, and enables avionics system 200 to communicate with other components of radar system 10. In addition, interface 206 can provide means of digital or analog signal communication with other components of aircraft 12, and/or a human interface operable by a human user such as a pilot or technician. In some embodiments, interface 206 can be a machine-to-machine interface such as a transceiver or adapter whereby a user interacting with a remote device can indirectly interface with avionics system 200.

AESA 210 is a phased array, e.g. installed on a common antenna, of multiple discrete RF channels 214 with associated antenna elements 212. Each antenna element 212 and associated RF channel 214 can, in some embodiments, act as both an emitter (i.e., generating components of beams of monopulse radar 100 in cooperation with other RF channels 214 as a phased array) and a receiver (i.e., receiving radar returns for processing by avionics system 200). Active antenna elements 212 collectively define the aperture of AESA 210, and are each capable of radiating an independent signal from respective RF channel 214. As noted above RF channels 214 can at least include a dedicated BFIC and TRM governed by beamforming module 220 (see below). RF channels 214 can have a serial peripheral interface (SPI) or non-serial bus. More generally, however, any appropriate signal channel can be used, so long as each RF channel 214 making up AESA 210 is capable of independent adjustment by and reporting to avionics system 200. As illustrated in FIG. 2, each antenna element 212 shares a common horizontal electric field polarization E with AESA 210, as a whole. More generally, however, other electric field polarizations can be shared by all elements 212 and by AESA 212 as a whole, including vertical or other-angled linear polarizations and/or circular polarizations.

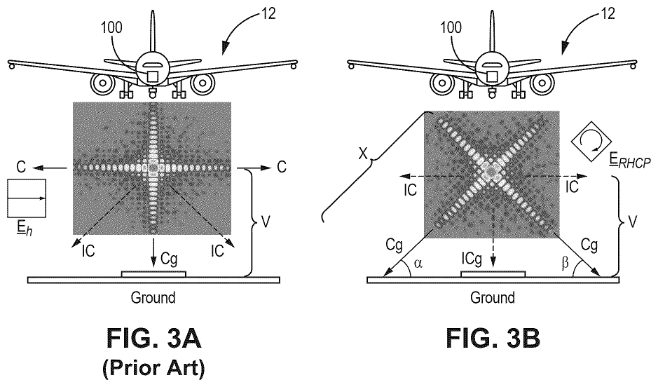

As discussed in greater detail with reference to FIGS. 3a and 3b, horizontal polarization (as shown in FIG. 2) can advantageously be replaced with half-duplexed circular polarization (e.g. switching between right-hand circular polarization (RPCP) and left-hand circular polarization (LHCP) (or vice versa) between reception and transmission) to facilitate rotation of sidelobe orientations while avoiding return polarization mismatches. In the illustrated embodiment, AESA 210 consists of a multitude of independently controllable RF channels 214 with associated antenna elements 212 distributed in a rectangular arranged on orthogonal axes. More generally, however, physical locations of antenna elements 212 need not always be physically arranged along axes forming independent bases, and alternative array geometries can be simulated at beamforming, notwithstanding physical locations of each antenna element 212. Furthermore, although AESA 210 is depicted as a dense array of active elements 212, sparser arrangements of active emitters (i.e., elements 212) can also be used, so long as array gaps to not introduce significant unwanted signal periodicity.

Non-radar sensors 216 can include any sensors coupled to avionics system 200, and not directly affected by the functioning of radar system 10. Non-radar sensors 216 can, for example, include non-radar-based altitude sensors, air data probes, ice detection systems, and landing gear status sensors, to name a few non-limiting examples. In some cases, sensor data from non-radar sensors 216 can be used to identify proximity to ground (e.g., during takeoff or landing), or direction towards nearest ground clutter sources, thereby facilitating ground clutter suppression as discussed below with respect to FIG. 3b.

Memory 204 is illustrated as hosting several functional software modules 220, 230, 240, and 250. These modules are collectively responsible for controlling radiation emission and processing return signals as known in the art, and are executed by avionics system 200 using processor 202. More specifically, beamforming module 220 is responsible for specifying amplitude and phase or time delay of radiation emission from all RF channels 214 as a phased array to produce multiple monopulse beams, while return processing module 230 is responsible for amplitude- or phase-based comparison of return signals, general noise reduction, and in some embodiments, imaging based on radar returns. Beamforming module 220 can, for example, be or include a beam steering controller (BSC) that collectively controls BFICs of each RF channel 214. In the illustrative embodiments principally described herein, beamforming module 220 defines three beams—a sum beam Σ, and an azimuth difference beam Δₐ, and an elevation difference beam Δₑ. Sum beam 2 can, for example, be defined by a Taylor-weighted beam profile to reduce sidelobe amplitude, while difference beams Δₐ and Δₑ can, for example, be defined by Bayliss-weighted beam profiles, Taylor-weighted beam profiles, and/or split Taylor-weighted beam profiles.

Transmit/receive module 240 is a duplexing switch configured to flip polarizations of RF channels 214 according to timing selected to enable reception of anticipated radar returns based on travel time delay. Transmit/receive module 240 operates broadly as known in the art, and disclosed in the context of horizontally polarized ESA radar systems in U.S. Pat. No. 11,280,880. Transmit/receive module 240 facilitates reception of reflected (i.e., reversed) signals from circularly polarized radar returns, as needed. For simplicity of explanation, FIG. 2 presents transmit/receive module (TRM) 240 as a variable-timing switching module separate from beamforming module 220. According to this presentation, TRM 240 is responsible only flipping antenna polarizations to facilitate duplex operation of monopulse radar 100. In alternative embodiments, however, functions of transmit/receive module 240 can be entirely integrated into the ordinary operation of beamforming module 220. In some embodiments, monopulse radar 100 can be reconfigurable between duplex and non-duplex operating modes. In such embodiments, transmit/receive module 240 can be disabled when not needed. In some embodiments, polarization switching governed by TRM 240 can be separate from (i.e., not simultaneous with) switching between transmit and receive modes of AESA 210, i.e., such that Tx/Rx switching is partly decoupled from polarization switching, e.g., for ground clutter identification using comparison of co- and cross-polarized returns as noted below with reference to FIG. 3b.

FIG. 3a is a simplified overlay of radar system 10 operating in a conventional aerial monopulse AESA configuration, with horizontal antenna polarization and cardinal sidelobes directed horizontally and vertically with respect to the ground. FIG. 3b is a simplified overlay radar of system 10 operating with a rotated radiation pattern facilitated with half-duplex circular polarization, as described below. FIGS. 3a and 3b are described together.

FIGS. 3a and 3b illustrate aircraft 12 (with monopulse radar 100) near the ground, e.g., during takeoff or landing, and show a radiant plot of illustrative sum beams Σ according to two approaches. Azimuth beam Δₐ and elevation beam Δₑ are not separately illustrated. FIGS. 3a and 3b illustrate different configurations of monopulse radar 100 aboard aircraft. Specifically, FIGS. 3a and 3b overlay provide radiant plots illustrating sidelobe patterns according to conventional (FIG. 3a) and reduced ground clutter (FIG. 3b) configurations of monopulse radar 100. Although radiant plots in FIGS. 3a and 3b are illustrated between aircraft 12 and ground, the sidelobe patterns illustrated in these plots should be understood to be centered on a borescope axis emitted from monopulse radar 100, i.e., from AESA 210.

As shown in FIGS. 3a and 3b, monopulse radar 100 is separated from the ground by a vertical distance V. Conventional aerial weather radar is commonly oriented as shown in FIG. 3a, with horizontally RF channels 214 producing linear (here, horizontal, but equivalently vertical) array polarization Eₕ for AESA 210 as a whole. In this orientation, with a rectangular aperture grid of AESA 210, the highest radiation amplitude away from the main lobe/borescope axis is oriented along cardinal axes C, which extend parallel to, orthogonally away from, and orthogonally (vertically) towards the ground. In FIG. 3a, cardinal sidelobes oriented along cardinal axis C_{g} are directed orthogonally (in the section plane of FIGS. 3a and 3b; obliquely in the borescope direction) with respect to the ground. As a consequence, ground clutter returns from these sidelobes are relatively strong, and can make distinguishing near-ground signals—such as from low altitude weather conditions such as wind shear and microbursts—unreliable or impossible.

FIG. 3b presents a monopulse radar pattern for ground clutter suppression with sidelobe orientations in a 45° shifted, circularly polarized, monopulse radar system enabled by the half-duplexing of circularly RHCP Tx and LHCP Rx radar pulses. Although this radar pattern could be produced by physically rotating a perimeter of AESA 210 (compared to FIG. 3a) with respect to an anticipated ground location, an HP version of the pattern of FIG. 3b can equivalently be produced without physically rotating a perimeter of AESA 210, through rotation of the array lattice within the AESA perimeter 210, i.e., either a static angular offset of the rectangular lattice, as referenced to vertical and horizontal axes as shown in FIG. 3A (the “vertical” axis defined by Cg and the “horizontal” axis defined by C), or by selectively activating particular elements 210, along with a uniform counter rotation of every radiating element within the rotated array lattice to retain the required HP polarization state. The location of sidelobes in the configuration of FIG. 3b greatly reduces likely ground clutter for several reasons, compared to the configuration of FIG. 3a. First, the intercardinal sidelobes along intercardinal axis IC_{g} are directed along a shortest path to ground, rather than cardinal sidelobes along cardinal axis C_{g} as in FIG. 3a. Because intercardinal sidelobe intensity falls of much more abruptly with distance from the borescope axis than cardinal lobe intensity (as the product of normalized cardinal sidelobe components), ground scatter from radiation along this most direct path to ground is minimal. Second, cardinal sidelobes capable of producing ground clutter (i.e., sidelobes oriented along cardinal axes C_{g}) are likely to intersect the ground obliquely, reducing radar return. Third, cardinal sidelobes oriented along cardinal axes C_{g} intersect the ground at higher peak order (lobe number) and/or after longer travel time, in either case further reducing radiation strength at intersection with the ground—and consequently reducing resulting ground clutter. In some instances, longer travel associated with travel along oblique cardinal axes C_{g} can also be used by return processing module 230 to distinguish (and thereby ignore) associated ground clutter.

For illustrative simplicity, aircraft 12 is shown flying parallel to the ground, and the ground is shown as flat, such that cardinal axes C_{g} intersect the ground at angles α=β=45°. In cases of more complex surface geometry, intersection angles α and β may not be equal, and may vary over time. Even in such cases, however, the configuration of FIG. 3b reduces ground clutter for all of the reasons set forth above. Where surface geometry is anticipated to not be parallel to the frame of reference of aircraft 12, such as while banking and/or while flying near mountains and other non-flat surfaces, beamforming module 220 can, in some embodiments, shift the radiation pattern of monopulse radar 100 by different angles (i.e., not 45°) so as to orient intercardinal axis IC_{g} generally along a shortest path towards the ground.

Adjusting radiation patterns to orient intercardinal sidelobes towards ground, as shown in FIG. 3b, would result in return polarization mismatching if polarization of AESA 210 were not adjusted accordingly (i.e., would result in radiation polarized obliquely with respect to the ground). As shown in FIG. 3b, monopulse radar 100 avoids this mismatch by circularly polarizing all elements of AESA 210. To facilitate detection of radar returns, transmit/receive module 240 handles polarization switching for half-duplexing between RHCP for radiation and LHCP for reception, or vice versa. In this manner, radar system 10 is able to freely accommodate rotation of sidelobe patterns about the borescope axis to minimize sidelobe ground clutter.

In addition to the advantages set forth above, half-duplexed circular polarization facilitates improved discrimination of ground returns through analysis of both co-polarized and cross-polarized comparative measurements of ground returns. As noted above in the context of facilitating radar return reception by half-duplexing RHCP/LHCP, target (i.e., desired) signal return will tend to be much stronger a first, co-polarized state than in a second, cross-polarized state. Ground returns, by contrast, will remain substantially constant in both polarization states. The consistency of ground returns across co- and cross-polarization states allows clutter strength to be accurately ascertained, and clutter signal isolated. Isolated clutter signal can then be subtracted from co-polarized radar returns, further improving ground clutter suppression. To facilitate ground clutter identification, TRM 240 can, as noted above with respect to FIG. 2, effectuate switching between polarizations separately from switching between Tx and Rx modes. For an embodiment wherein transmission uses LHCP, for example, TRM 240 can decouple polarization switching to receive returns while with AESA 210 in both LHCP and RHCP polarizations to facilitate identification of ground clutter. Once identified or confirmed, TRM 240 can cause AESA 210 to receive predominantly or exclusively in a RHCP, i.e. co-polarized, mode, switching back to include cross-polarized reception only for subsequent re-evaluation of ground clutter location.

The angling of cardinal side lobes obliquely with respect to ground both reduces ground clutter returns and improves distinguishability of those returns so that they may be isolated and subtracted, as noted above. The half-duplexed LHCP/RHCP approach also set forth herein facilitates the array orientation noted above, and independently provides additional tools for identifying and isolating ground clutter.

### DISCUSSION OF POSSIBLE EMBODIMENTS

The following are non-exclusive descriptions of possible embodiments of the present invention.

A method for suppressing ground clutter in a monopulse active electronically scanned array (AESA) radar system including a phased array of radio-frequency channels, the method comprising: identifying an axis transverse to a borescope axis defining a shortest path to a ground surface; forming a plurality of monopulse beams using the phased array, each of the plurality of beams having radiation patterns with intercardinal sidelobes oriented along the identified axis; and alternating between right-hand circular polarization and left-hand circular polarization of the phased array with timing selected for half-duplexing for radiation and detection of radar returns.

The method of the preceding paragraph can optionally include, additionally and/or alternatively, any one or more of the following features, configurations and/or additional components:

A further embodiment of the foregoing method, wherein each of the plurality of beams has cardinal sidelobes oriented obliquely with respect to the ground surface.

A further embodiment of the foregoing method, further comprising: identifying radar returns from cardinal side lobes based on time-of-flight; and reducing ground clutter by subtracting radar returns from cardinal side lobes from return received radar returns.

A further embodiment of the foregoing method, wherein the cardinal sidelobes are oriented at 45° with respect to an expected position of the ground surface.

A further embodiment of the foregoing method, further comprising: receiving first radar returns while the phased array is right-hand circular polarized; receiving second radar returns while the phased array is left-hand circular polarized; identifying ground clutter by comparison of co- and cross-polarized returns, relative to transmitted radiation; and reducing ground clutter by subtracting identified ground clutter from co-polarized returns.

A further embodiment of the foregoing method, wherein: the AESA radar system includes a plurality of emitters arranged in a grid within a rectangular effective aperture, each RF channel corresponding to one of the emitters; and cardinal sidelobes of each of the plurality of beams are not aligned with perimeter edges of the rectangular effective aperture.

A method for suppressing ground clutter in a monopulse active electronically scanned array (AESA) radar system including a phased array of radio-frequency channels, the method comprising: emitting radiation in a plurality of monopulse beams from the phased array, while the phased array is circularly polarized in a first direction; receiving first radar returns while the phased array is co-polarized with the first direction; receiving second radar returns while the phased array is cross-polarized with the first direction; identifying ground clutter based on comparison of ground clutter strength in the first and second radar returns; and subtracting the identified ground clutter from the first radar returns to produce a ground clutter-reduced radar signal.

The method of the preceding paragraph can optionally include, additionally and/or alternatively, any one or more of the following features, configurations and/or additional components:

A further embodiment of the foregoing method, wherein identifying ground clutter comprises identifying return components of equal strength in the first radar return and the second radar return as likely ground clutter.

A further embodiment of the foregoing method, wherein each of the plurality of beams has a radiation pattern with cardinal sidelobes oriented obliquely with respect to a ground surface.

A further embodiment of the foregoing method, wherein each of the plurality of beams has a radiation pattern with intercardinal sidelobes oriented along a shortest path to the ground surface.

An aerial monopulse active electronically scanned array (AESA) radar system comprising: a phased array of independently controllable radio frequency (RF) channels, each RF channel governing a single emitter element; a beamforming module configured to cause the phased array to produce a radiation pattern with intercardinal sidelobes oriented along a shortest axis to ground, during flight; and a transmit/receive module configured to half-duplex operation of the phased array by switching between left-hand circular polarization and right-hand circular polarization.

The aerial monopulse AESA radar system of the preceding paragraph can optionally include, additionally and/or alternatively, any one or more of the following features, configurations and/or additional components:

A further embodiment of the foregoing aerial monopulse AESA radar system, wherein each of the RF channels comprises a beamforming integrated circuit (BFIC) and a transmit/receive module (TRM).

A further embodiment of the foregoing aerial monopulse AESA radar system, further comprising a return processing module configured to process radar returns received via the half-duplex operation specified by the transmit-receive module.

A further embodiment of the foregoing aerial monopulse AESA radar system, wherein the return processing module is configured to identify ground clutter in the radar returns, and subtract the ground clutter to produce a reduced-clutter signal.

A further embodiment of the foregoing aerial monopulse AESA radar system, wherein identifying the ground clutter comprises distinguishing ground clutter from cardinal sidelobes based on longer time-of-flight, as compared to borescope and intercardinal returns.

A further embodiment of the foregoing aerial monopulse AESA radar system, wherein identifying the ground clutter comprises distinguishing ground clutter as signal of equal magnitude in co- and cross-polarized returns.

A further embodiment of the foregoing aerial monopulse AESA radar system, wherein the phased array is orientable downward, towards a ground surface.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### SUMMATION

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for suppressing ground clutter in a monopulse active electronically scanned array (AESA) radar system including a phased array of radio-frequency channels, the method comprising:
identifying an axis transverse to a borescope axis defining a shortest path to a ground surface;
forming a plurality of monopulse beams using the phased array, each of the plurality of beams having radiation patterns with intercardinal sidelobes oriented along the identified axis; and
alternating between right-hand circular polarization and left-hand circular polarization of the phased array with timing selected for half-duplexing for radiation and detection of radar returns.

2. The method of claim 1, wherein each of the plurality of beams has cardinal sidelobes oriented obliquely with respect to the ground surface.

3. The method of claim 2, further comprising:
identifying radar returns from cardinal side lobes based on time-of-flight; and
reducing ground clutter by subtracting radar returns from cardinal side lobes from return received radar returns.

4. The method of claim 2, wherein the cardinal sidelobes are oriented at 45° with respect to an expected position of the ground surface.

5. The method of claim 1, further comprising:
receiving first radar returns while the phased array is right-hand circular polarized;
receiving second radar returns while the phased array is left-hand circular polarized;
identifying ground clutter by comparison of co- and cross-polarized returns, relative to transmitted radiation; and
reducing ground clutter by subtracting identified ground clutter from co-polarized returns.

6. The method of claim 1, wherein:
the AESA radar system includes a plurality of emitters arranged in a grid within a rectangular effective aperture, each RF channel corresponding to one of the emitters; and
cardinal sidelobes of each of the plurality of beams are not aligned with perimeter edges of the rectangular effective aperture.

7. A method for suppressing ground clutter in a monopulse active electronically scanned array (AESA) radar system including a phased array of radio-frequency channels, the method comprising:
emitting radiation in a plurality of monopulse beams from the phased array, while the phased array is circularly polarized in a first direction;
receiving first radar returns while the phased array is co-polarized with the first direction;
receiving second radar returns while the phased array is cross-polarized with the first direction;
identifying ground clutter based on comparison of ground clutter strength in the first and second radar returns; and
subtracting the identified ground clutter from the first radar returns to produce a ground clutter-reduced radar signal.

8. The method of claim 7, wherein identifying ground clutter comprises identifying return components of equal strength in the first radar return and the second radar return as likely ground clutter.

9. The method of claim 7, wherein each of the plurality of beams has a radiation pattern with cardinal sidelobes oriented obliquely with respect to a ground surface.

10. The method of claim 9, wherein each of the plurality of beams has a radiation pattern with intercardinal sidelobes oriented along a shortest path to the ground surface.

11. An aerial monopulse active electronically scanned array (AESA) radar system comprising:
a phased array of independently controllable radio frequency (RF) channels, each RF channel governing a single emitter element;
a beamforming module configured to cause the phased array to produce a radiation pattern with intercardinal sidelobes oriented along a shortest axis to ground, during flight; and
a transmit/receive module configured to half-duplex operation of the phased array by switching between left-hand circular polarization and right-hand circular polarization.

12. The aerial monopulse AESA radar system of claim 11, wherein each of the RF channels comprises a beamforming integrated circuit (BFIC) and a transmit/receive module (TRM).

13. The aerial monopulse AESA radar system of claim 11, further comprising a return processing module configured to process radar returns received via the half-duplex operation specified by the transmit-receive module.

14. The aerial monopulse AESA radar system of claim 13, wherein the return processing module is configured to identify ground clutter in the radar returns, and subtract the ground clutter to produce a reduced-clutter signal.

15. The aerial monopulse AESA radar system of claim 14, wherein identifying the ground clutter comprises distinguishing ground clutter from cardinal sidelobes based on longer time-of-flight, as compared to borescope and intercardinal returns.

16. The aerial monopulse AESA radar system of claim 15, wherein identifying the ground clutter comprises distinguishing ground clutter as signal of equal magnitude in co- and cross-polarized returns.

17. The aerial monopulse AESA radar system of claim 11, wherein the phased array is orientable downward, towards a ground surface.
